(19) United States
(12) Patent Application Publication
(10) Pub. No.: US 2025/0045745 A1
(43) Pub. Date: Feb. 6, 2025

(54) BLOCKCHAIN-BASED DECENTRALIZED PAYMENT METHOD

(71) Applicant: Uniqloop Hong Kong Limited, Hong Kong (CN)

(72) Inventor: YIK ON IVAN CHAN, HONG KONG (CN)

(73) Assignee: Uniqloop Hong Kong Limited, Hong Kong (CN)

(21) Appl. No.: 18/531,204

(22) Filed: Dec. 6, 2023

(30) Foreign Application Priority Data
Aug. 2, 2023 (CN) 202310967539.3

(51) Int. Cl. G06Q 20/38; G06Q 20/12; G06Q 20/36

(52) U.S. Cl. CPC G06Q 20/389; G06Q 20/1235; G06Q 20/3672

(57) ABSTRACT

A decentralized payment method is provided. The method includes: a first terminal obtaining entry information of a transaction space of a second terminal; the first terminal skipping to a page of the transaction space of the second terminal based on the entry information, wherein the page is configured to display product rights bound to non-fungible tokens; the first terminal associating a first digital wallet of the first terminal with the transaction space; the first terminal making payment in the transaction space using the first digital wallet based on transaction amount of the product rights selected by a user, and minting the non-fungible tokens bound to the product rights selected by the user, so that the first terminal owns the product rights corresponding to the minted non-fungible tokens. The present disclosure improves the transparency and security of the payment process.

### CROSS-REFERENCE TO RELATED APPLICATIONS

The present disclosure is based upon and claims priority to Chinese Patent Application No. 202310967539.3, filed on Aug. 2, 2023, the entire contents of which are incorporated herein by reference.

### TECHNICAL FIELD

The present disclosure relates to the field of blockchain technology, specifically a blockchain-based decentralized payment method.

### BACKGROUND

Traditional payment modes are generally implemented through direct currency transactions or relying on third-party payment platforms, which often leads to insufficient disclosure of transaction information and inadequate security for payment processes and transaction record. In addition, the third-party payment platforms will generate additional unnecessary cost and time costs.

Blockchain technology is a technology solution that does not rely on third parties and stores, verifies, transmits, and communicates network data through its own distributed nodes. There have been some blockchain-based transactions methods in existing technology. However, the existing methods only upload data from various links in the payment process to the blockchain to ensure that data is not easily tampered with. These methods mainly add an additional process of data uploading on the basis of traditional payment modes, which cannot solve problems such as improving payment efficiency and improving transaction information transparency.

In addition, during the transaction process of physical products, at various levels of the supply chain, based on the transferring number of product ownerships, additional expenses, including but not limited to warehousing, logistics, and corresponding operating expenses, will be required each time, and a lot of time costs will be consumed in each sale link, resulting in a significant increase in the overall cost of product circulation, and the speed of product circulation in the market is slow.

### SUMMARY

To solve the technical problems in the existing technology, the present disclosure provides a blockchain-based decentralized payment method, which combines blockchain technology with Web3.0 technology to improve the transparency and security of the payment process, improves the efficiency of the payment process, and avoids asymmetry and inauthenticity of product information.

The embodiment of the present disclosure provides a blockchain-based decentralized payment method, including: a first terminal obtaining entry information of a transaction space of a second terminal: the first terminal skipping to a page of the transaction space of the second terminal based on the entry information, wherein the page is configured to display product rights owned by the second terminal, and the product rights are bound to non-fungible tokens: the first terminal associating a first digital wallet of the first terminal with the transaction space of a second terminal; the first terminal making payment in the transaction space of the second terminal using the first digital wallet based on transaction amount of the product rights selected by a user, and minting the non-fungible tokens bound to the product rights selected by the user, so that the first terminal owns the product rights corresponding to the minted non-fungible tokens.

In some embodiments, the step of the first terminal obtaining the entry information of the transaction space of a second terminal includes: the first terminal obtaining a transaction link for product rights of a specified category owned by the second terminal, wherein the page of the transaction space of the second terminal is configured to display the product rights of the specified category owned by the second terminal.

In some embodiments, the step of the first terminal obtaining a transaction link for product rights of a designated category owned by the second terminal includes: the first terminal taking a photo of a projection screen showing a product, and obtaining a transaction link for product rights of a designated category corresponding to the displayed product based on the projection screen.

In some embodiments, the step of the first terminal obtaining a transaction link for product rights of a designated category owned by the second terminal includes: the first terminal taking a photo of a displayed product, identifying the photo to determine a category of the displayed product, and obtaining a transaction link for the product rights of a specified category corresponding to the displayed product.

In some embodiments, the step of the first terminal obtaining a transaction link for product rights of a designated category owned by the second terminal includes: the first terminal logging into a payment platform, wherein the payment platform is configured with an application programming interface, and the second terminal is configured to access the payment platform through a created decentralized application or through an Internet e-commerce sales platform, and upload product right data owned by the second terminal to the blockchain; the first terminal retrieving and obtaining product rights of a specified category or corresponding smart contracts through the payment platform, and obtaining the transaction link for the product rights of the specified category in the decentralized application.

In some embodiments, before the first terminal obtaining the entry information of the transaction space of a second terminal, the method further includes the following steps: the second terminal uploading the product right data owned by the second terminal to the blockchain, and binding each product right with non-fungible tokens in a DA-Tie format.

In some embodiments, the product right data at least includes product category, product number, product specification, and production information corresponding to each product right.

In some embodiments, after the first terminal owns the product rights corresponding to the minted non-fungible tokens, the method further includes the following steps: the first terminal receiving a product exchanging instruction from the user, determining the product rights to be exchanged and product acquisition method; after receiving a successful product exchange instruction, the first terminal calling a first smart contract to destroy the non-fungible tokens corresponding to the product rights to be exchanged.

In some embodiments, after the step of determining the product rights to be exchanged and product acquisition method, the method further includes the following steps: if the product acquisition method of the product is for the user to pick up the product, based on the non-fungible tokens bound to the product rights to be exchanged, the first terminal obtaining and displaying a location of the product corresponding to the product rights to be exchanged: if the product acquisition method of the product is logistics delivery, based on the non-fungible tokens bound to the product rights to be exchanged, the first terminal obtaining information of a product supplier corresponding to the product rights to be exchanged, obtaining the user's address bound to the first terminal, generating a logistics delivery order, and pushing the order to a corresponding logistics management system of the product supplier.

In some embodiments, the method further includes the following steps: the first terminal disclosing entry information of a transaction space of the first terminal or sending the entry information corresponding to the product rights to a third terminal in a form of DA-Send; the third terminal skipping to a page of the transaction space of the first terminal based on the entry information, making payment and minting non-fungible tokens corresponding to required product rights using a third digital wallet associated with the third terminal, so that the third terminal owns the required product rights.

In some embodiments, the method further includes the following steps: obtaining digital profits to be distributed and determining the non-fungible tokens corresponding to the digital profits: determining the beneficiaries corresponding to the digital profits based on the non-fungible tokens corresponding to the digital profits: calling a second smart contract to distribute the digital profits to be distributed to the beneficiaries.

In some embodiments, the step of calling a second smart contract to distribute the digital profits to be distributed to the beneficiaries includes the following steps: obtaining holding amounts and durations of the product rights owned by the beneficiaries: obtaining a contribution record of the beneficiaries to the product rights: calculating contribution values of the beneficiaries based on a preset contribution value calculation method, according to the holding amounts, holding durations, and the contribution records of the beneficiaries: calling the second smart contract, calculating income value distributed to each beneficiary, and distributing the digital profits to be distributed to the beneficiaries, based on the contribution value of each beneficiary.

In some embodiments, wherein before the step of the first terminal making payment in the transaction space of the second terminal using the first digital wallet based on the value of the product rights selected by a user, the method further includes the following steps: determining amount of product rights selected by the user: based on a preset product right value calculation method, determining a unit price of the product rights and the value of the product rights selected by the user, with the value comprising transaction amount of payable tokens and/or transaction amount of non-fungible tokens.

The present disclosure combines blockchain technology with Web3.0 technology, which can convert the transaction of physical products into the conversion of product rights, and can realize the decentralized transaction of the product right based on the blockchain through the binding between the product rights and non-fungible tokens, improving transparency and security of the payment process, improving the efficiency of the payment process, and avoiding asymmetry and inauthenticity of product information. During the transaction process using the method of the present disclosure, two users exchange the product rights rather than the physical products. When the user chooses to continue to own the product right, there is no need to transfer the location of the physical product, which greatly saves the cost and time of logistics and distribution, and also reduces middleman costs. The user can choose to own the product rights or exchange it for physical products, or can further transfer the product rights owned by himself to other users. For users who do not have their own warehousing resources, there is no need to provide additional warehousing of physical products, as there is no need to transfer the location of physical products, which also reduces the waste of materials and costs caused by excessive packaging of products. Therefore, the present disclosure will help speed up the circulation of products and encourage more users to participate. Under this payment model, some users have also changed their status from consumers to contributors, which not only increases the circulation speed of products, but also increases spontaneous market circulation and conversion rate for brand promotion.

### BRIEF DESCRIPTION OF THE DRAWINGS

The foregoing and other features, and advantages of the invention are apparent from the following detailed description taken in conjunction with the accompanying drawings in which:

FIG. 1 is a flow chart of the blockchain-based decentralized payment method according to an embodiment of the present disclosure:

FIG. 2 is a schematic view of an implementation architecture of the blockchain-based decentralized payment method of the present disclosure;

FIG. 3 is a schematic view of a specific progress of the blockchain-based decentralized payment method of the present disclosure;

FIG. 4 is a schematic view of another implementation architecture of the blockchain-based decentralized payment method of the present disclosure:

FIG. 5 is a schematic view of another specific progress of the blockchain-based decentralized payment method of the present disclosure:

FIG. 6 is a flowchart of converting physical products according to an embodiment of the present disclosure:

FIG. 7 is a schematic view of a decentralized payment process of the present disclosure.

### DETAILED DESCRIPTION

The exemplary embodiments will be described more comprehensively referring to the accompanying drawings. However, the exemplary embodiments can be implemented in multiple forms and should not be limited to the embodiments described herein: on the contrary, providing these implementation methods makes the present disclosure comprehensive and complete, and fully conveys the concept of the embodiments to those skilled in the art. The same reference numbers in the figures represent the same or similar structures, so repeated descriptions of them will be omitted. The words “or” and “or” in the description may all indicate “and” or “or”. Some of the block diagrams shown in the attached drawings show functional entities, which do not necessarily correspond to physically or logically independent entities. These functional entities can be implemented in software form, or in one or more hardware modules or integrated circuits, or in different networks and/or processor devices and/or microcontroller devices. Although “first” or “second” are used in this description to represent certain features, they are only used for distinguishing and not as a limitation on the number and importance of specific features.

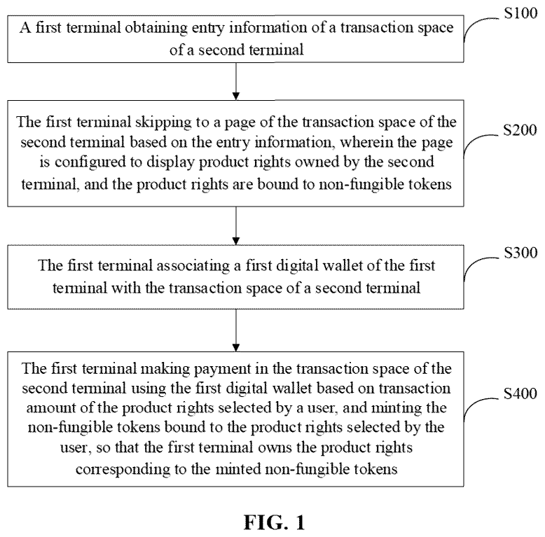

As shown in FIG. 1, the present disclosure provides a blockchain-based decentralized payment method, including the following steps:

S100: a first terminal obtaining entry information of a transaction space of a second terminal;

The first terminal and the second terminal herein are, for example, terminal devices (such as mobile phones, tablets, laptops, etc.), or software terminals used by the user (APPs, browsers, etc.) used by the user, which are bound to digital wallets; the user herein can refer to an ordinary consumer or a merchant. For example, the first terminal is the user terminal of consumer X, the second terminal is the user terminal of consumer Y, or the first terminal is the user terminal of the consumer, the second terminal is the merchant terminal, or the first terminal is the merchant terminal and the second terminal is the user terminal of the consumer, or the first terminal is the merchant terminal 1 and the second terminal is the merchant terminal 2, etc. The following description takes the first terminal as the user terminal of the consumer and the second terminal as the merchant terminal as an example, but the present disclosure is not limited to this:
S200: the first terminal skipping to a page of the transaction space of the second terminal based on the entry information, wherein the page is configured to display product rights owned by the second terminal, and the product rights are bound to non-fungible tokens;
the second terminal is bound to a second digital wallet, wherein the product rights owned by the second terminal in the transaction space of the second terminal is the product rights corresponding to the non-fungible tokens owned by the second digital wallet of the second terminal;
that is, the first terminal logs in the distributed asset space based on Web3.0 according to the entry information of the transaction space of the second terminal, specifically, enters the transaction space of the second terminal and can view the product rights owned by the second terminal from the page of the transaction space of the second terminal. The products in the present disclosure may refer to one or more of physical products, services, virtual digital products and financial products, and are not limited to the categories listed herein. Among them, physical products are, for example home furnishings, clothing, food that can be purchased in physical stores: services are, for example haircuts, physical examinations, and nursing care; and virtual digital products are, for example videos, audios, e-books, games, live broadcasts, or recorded products (courses, ball games, etc.), financial products are, for example insurance products, funds. Take physical products as an example. There is a one-to-one correspondence between the product rights and the physical products, and there is also a correspondence between the product rights and the non-fungible tokens (NFT, Non-Fungible Token, a trusted digital rights certificate with unique characteristics in the blockchain network, is a data object that can record and process multi-dimensional and complex attributes on the blockchain);
The products referred to in the present disclosure may be, for example, mineral water, paper towels, furniture, electrical appliances and other physical products that people usually buy. The product right refers to the ownership of a certain product. For example, a merchant owns 100 bottles of mineral water of a certain brand, and the merchant binds the product rights of these 100 bottles of mineral water to NFT, then the first terminal can view and verify the product rights of these 100 bottles of mineral water on the page of the transaction space of the second terminal, and purchase them;
S300: the first terminal associating a first digital wallet of the first terminal with the transaction space of a second terminal;
S400: the first terminal making payment in the transaction space of the second terminal using the first digital wallet based on transaction amount of the product rights selected by a user, and minting the non-fungible tokens bound to the product rights selected by the user, so that the first terminal owns the product rights corresponding to the minted non-fungible tokens.

For example, if the first terminal purchases 10 bottles of mineral water on the transaction space of the second terminal, it uses the first digital wallet to make the payment of the payable tokens corresponding to these 10 bottles of mineral water to the second digital wallet of the second terminal, and mints the non-fungible tokens corresponding to these 10 bottles of mineral water, and transfers this part of the non-fungible tokens to the first digital wallet of the first terminal, thereby transferring the product rights of these 10 bottles of mineral water to the first terminal, and the second digital wallet of the second terminal receiving the profits of these 10 bottles of mineral water. The payment herein is not limited to the payment of payable tokens, but can also be the payment of non-fungible tokens. For example, the first terminal can also use other non-fungible tokens of equal value to pay the second terminal.

Therefore, the present disclosure provides a decentralized payment method based on the Internet, and can realize the transaction and management of product rights through this payment method. Currently, the Internet has become an indispensable part of people's lives. Payment and transaction through the Internet can improve timeliness and convenience. However, with the development and popularization of the Internet, some problems and limitations have gradually emerged. Firstly, the current Internet model has problems of centralization. Big tech companies have a monopoly on user data and platform control, causing users to lose control and sovereignty over their own data. In addition, these companies also make huge profits through advertising and commercial exploitation of personal data, for which users often do not receive fair returns. Secondly, the security and privacy protection of the Internet also face challenges. The traditional centralized architecture is vulnerable to hacker attacks and data leakage risks, posing potential threats to users' personal information and assets. In addition, due to lack of transparency and trust mechanisms, it is difficult for users to determine whether their interactions with other participants are safe and reliable. Thirdly, the sustainability issue in the Internet has become increasingly prominent. The traditional Internet model relies on massive energy consumption and centralized server architecture, which puts huge pressure on the ecological environment. At the same time, many innovative projects struggle to receive adequate support and development due to lack of incentive mechanisms and sustainable business models.

The emergence of Web3.0 has improved the current Internet model to a certain extent. Web3.0, based on the blockchain and decentralized technology, aims to redefine the architecture and mode of operation of the Internet, which gives users greater data sovereignty and control, enables programmable interactions through smart contracts, and provides higher security, privacy protection, and sustainability. The core concept of Web3.0 is to establish an open, decentralized Internet ecosystem that enables participants to interact and cooperate directly without relying on middlemen or third parties to build trust and consensus mechanisms. It provides a broader platform for innovators and developers, encouraging them to jointly promote technological progress and social reform.

In response to the first aspect of the above-mentioned problems, the core of Web3.0 is decentralization, using blockchain technology to build a distributed network, eliminating the centralized architecture of the traditional Internet, and no longer setting a single control point, so participants can interact and collaborate directly without relying on middlemen or third-party trusted authorities. In response to the second aspect of the above-mentioned problems, Web3.0 gives users greater data sovereignty and control. Users can own their own data and decide how to use, share and benefit from these data. Users can better protect personal privacy and data security through encryption and decentralized storage. In Web3.0, programmable codes based on the blockchain can automatically execute contract terms and adjustments by using smart contracts, so that transactions and agreements can be carried out without third-party intervention, increasing the efficiency and reliability of interactions. In response to the third aspect of the above-mentioned problems, Web3.0 reduces overall energy consumption and environmental impact by using the energy-efficient consensus algorithm and the distributed storage technology. Further, Web3.0 encourages the use of cryptocurrencies (such as Bitcoin and Ethereum) and token economy models. Cryptocurrencies can be used as a medium for value exchange, and token economy models can incentivize users to participate and contribute to the network. This economy model provides more opportunities and incentives for innovators and developers to create a more open, free and fair digital world.

Based on this, the present disclosure is committed to using the advantages of Web3.0 to solve the problems faced by the current Internet and bring users a more open, secure and autonomous Internet experience, and promote decentralized innovation and social reform based on the Internet environment that Web3.0 grants personal data ownership and management rights. The present disclosure can also further promote the development of Web3.0 and create more opportunities and benefits for global users through innovative technical architecture and business models. Specifically, the present disclosure combines blockchain technology with Web3.0 technology, which can convert the transaction of physical products into conversion of the product right, and can realize the decentralized transaction of the product right based on the blockchain through the binding between the product right and non-fungible tokens. The payment records and transfer records of product rights of both parties to the transaction are uploaded to the blockchain. The feature of not being easily tampered with based on the blockchain ensures the authenticity and effectiveness of the payment process, and improves the openness and security of the payment process. The present disclosure does not need to rely on a third-party payment platform, thus avoiding third-party handling fees and additional supply chain costs generated by the third-party payment platform, which is conducive to increasing the seller's profits and reducing the purchase price for terminal users. When the first terminal purchases products from the second terminal, it saves the user the traditional payment steps of selecting physical products, taking them to the counter to wait for checkout, and waiting for the cashier to check out. It only needs to conduct peer-to-peer payment between the first terminal and the second terminal, thus greatly improving the efficiency of the payment process.

During the transaction process using the method of the present disclosure, two users exchange product rights instead of physical products. That is, after the user pays the payable token corresponding to the product right, he obtains the right to own the product right, who can choose to exchange the non-fungible tokens he owns for physical products at a designated product storage location, or he can choose to continue owning non-fungible tokens for the product right without exchanging them. When the user chooses to continue to own non-fungible tokens for the product right, there is no need to move the location of the physical product. The physical product can continue to be placed in its original storage location, which greatly saves the cost and time of logistics and distribution. The user can also further transfer the product right owned by himself to other users. For example, user X transfers the product right owned by himself to user Y. After user Y pays the token and obtains the non-fungible token of the product right, he can go directly to the original product storage location to redeem the physical product without going through user X's transfer if he needs to exchange for the physical product, which also reduces the cost incurred by transfer of the middleman. For the user who doesn't have warehousing resources of his own, when he chooses to continue to own non-fungible tokens of the product right, the burden of warehousing is reduced as there is no need to move the location of the physical product, and there is no need to provide additional warehousing of the physical product. Since the circulation of the product right between different merchants/consumers does not require the actual transfer of the location storage of the physical product, it only requires peer-to-peer transaction of non-fungible tokens and payable tokens in the virtual distributed transaction space. The transaction speed is faster, which will help speed up the circulation of products and encourage more users to participate as well.

In the embodiment, before the step S100: the first terminal obtaining the entry information of the transaction space of a second terminal, the method further comprises the following steps:
the second terminal uploading the product right data owned by the second terminal to the blockchain, and binding each product right with non-fungible tokens in a one-to-one correspondence. The binding process herein is DAT (DA-Tie) process. The data of the product right at least includes the product category, product number, product specification and manufacture information corresponding to the product right. The product manufacturing information herein includes, for example, one or more of the product brands, manufacture date, place of origin and other related information.

In the process of the traditional product transaction, the authenticity of manufacture information is often difficult to guarantee. For example, merchants, manufacturers, etc. may maliciously modify information such as product brand, product origin, product manufacture date, etc., resulting in incorrect product information seen by users in the store, which is difficult to trace when there is a problem with the product. While by using the method of the present disclosure, all the product right data is stored in the blockchain, which can ensure that the source, manufacturing process, quality and other information of the product are recorded on the blockchain that cannot be tampered with. After the first terminal enters the page of the transaction space of the second terminal, it can view the product rights owned by the second terminal, and can easily view the manufacture information corresponding to the product right. These product information, such as the source of raw materials, manufacturing location, manufacture date, quality inspection report, etc., is uploaded to the blockchain by the merchant terminal and cannot be tampered with or removed, thus ensuring the absolute authenticity of the product information seen by users, avoiding asymmetry and inauthenticity of the product information, greatly ensuring transaction security and traceability of the product transaction, effectively preventing behaviors of imitative products, copycat products and modification of key product information. For a product, after its product right is uploaded to the chain by the original product supplier, no matter how many times it is circulated among users, its corresponding product manufacturing information will not change from beginning to terminal. Users can directly view the original manufacturing information of the product without worrying about the authenticity of this manufacturing information. This will increase consumers' trust in products and encourage product suppliers to pay more attention to product quality, information authenticity and transparency. Moreover, by uploading the product right data to the chain, full traceability of products can be achieved. Consumers can track every aspect of the product, from procurement of raw materials to manufacturing, logistics and sales, which helps identify forged and fake and infringing products and protect the right of consumers and copyright owners. Therefore, uploading the product right data to the chain can effectively help fight against the circulation of forged and fake and pirated products. Each product can be set with a unique identifier and product information, and consumers can verify the authenticity and legality of the product through the blockchain to avoid purchasing forged and fake or pirated products. Moreover, the cost of document handover and verification caused by the need for certified symmetry of product information is greatly reduced in this process. Since the authenticity of the product can be guaranteed, what users see is what they get, and there will be no situation where it's discovered that the product does not meet the expectation after redeeming it for physical product, thus reducing the probability of transaction cancellation and reducing unnecessary costs incurred by return, refund or compensation during the transaction process.

On the basis of the present disclosure, it can also provide support for sharing economy and circular economy, in addition to being applied to the sales of new products. For example, by uploading the right data corresponding to sharing resources (such as shared cars, shared office spaces, etc.) and recycled products (such as second-hand products, recycled products, etc.) to the chain, other users can pay to purchase the corresponding product right, thereby achieving effective utilization and sharing of resources and reducing resource waste and environmental burden. At the same time, uploading the product right data to the chain will provide an open platform for enterprises, innovators and developers to promote economy and cooperation. By sharing product data and smart contract functions, it can stimulate new business models and services and promote industry innovation and development.

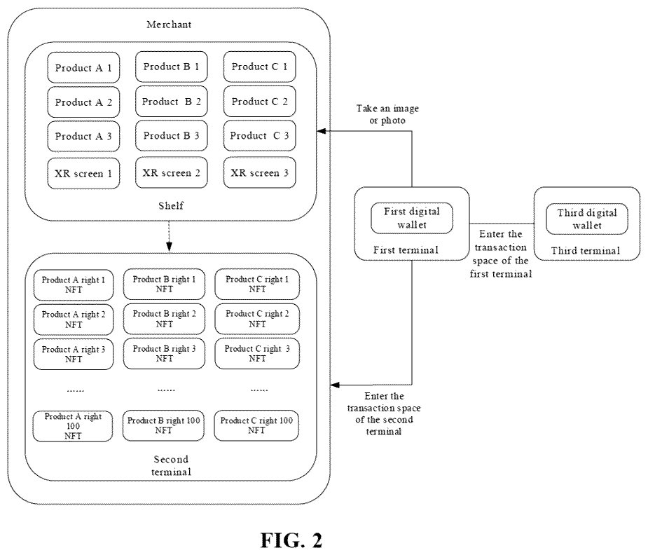

FIG. 2 is a schematic view of an implementation architecture of the blockchain-based decentralized payment method of the present disclosure. Take the structure shown in FIG. 2 as an example. The first terminal is, for example, a terminal used by a consumer, which is bound to the first digital wallet. The second terminal is, for example, a terminal of a merchant with a physical store. The merchant has some products put on the shelves of the physical store, but there are still many stored products in the merchant's warehouse that have not been put on the shelves. For example, the merchant has three categories of products put on the shelves; product A, product B, and product C, and only three shares of each product are placed. The product rights of these three shares are bound to non-fungible tokens, and there are actually 97 shares of product A, 97 shares of product B, and 97 shares of product C in the warehouse, which are also bound to non-fungible tokens. Therefore, the second terminal actually owns 100 non-fungible tokens for product A, 100 non-fungible tokens for product B, and 100 non-fungible tokens for product C.

In this embodiment, the second terminal may own product rights of multiple product categories, and the first terminal only needs to identify a certain product to enter the transaction space of the product right of a category corresponding to this product. Specifically, the step S100: the first terminal obtaining entry information of the transaction space of the second terminal, including the first terminal obtains the transaction link (for example, a URL address) for the product right of a specified category owned by the second terminal, and the page of the transaction space of the second terminal is configured to display the product right of a specified category owned by the second terminal. Taking FIG. 2 as an example, a user on the first terminal needs to purchase 5 shares of product B. After obtaining the transaction link corresponding to product B in the transaction space of the second terminal, the user clicks on the transaction link on the first terminal to jump to the page of the transaction space of the second terminal. This page shows that there are 100 shares of product B rights available for purchase in the transaction space of the second terminal. The user can select the number of shares he needs to purchase in the transaction space of the second terminal and make payment to obtain 5 shares of non-fungible tokens of product B rights.

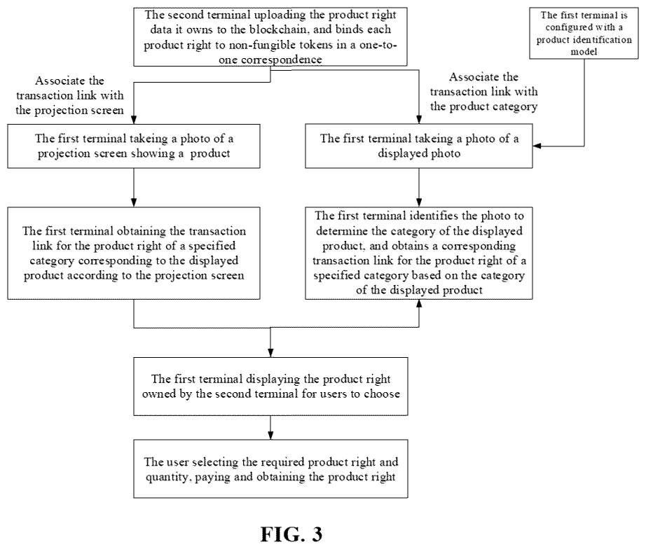

As shown in FIG. 3, when using the embodiment architecture of FIG. 2, the second terminal firstly uploads all the product right data it owns to the blockchain, and binds each of the product rights to non-fungible tokens in a one-to-one correspondence, and then the transaction link for the product right can be configured to be associated with the projection screen or with the product category. After the first terminal obtains the transaction link and enters the page of the transaction space of the second terminal, the user can view the product rights owned and sold by the second terminal, select the product right and amount to be purchased, and make payment to obtain the corresponding product right.

As shown in FIG. 3, in this embodiment, if the transaction link for the product right is configured to be associated with the projection screen, the first terminal obtaining the transaction link for the product right of a specified category owned by the second terminal, includes the first terminal taking a photo of a projection screen showing a product, and obtains a transaction link for the product right of a specified category corresponding to the displayed product based on the projection screen. This projection screen is, for example, an XR (Extended Reality) screen, and this XR screen is used as the entrance to the transaction space of the second terminal. The XR screen can display advertising images corresponding to physical products, which not only attracts consumers, but also serves as an entrance to the distributed transaction space. After the user uses the first terminal to take photos of the XR screen and recognizes the picture of the XR screen, the user can obtain the corresponding transaction link and enter the virtual transaction space corresponding to the specified product. Taking FIG. 2 as an example, the merchant can place a large XR screen at the entrance of the merchant, which displays advertisements for various physical products. When the first terminal captures a picture of a certain physical product, it can enter the virtual transaction space corresponding to the product. Alternatively, the merchant can set up an XR screen on the shelf corresponding to each product category, for example, set up XR screen 1, XR screen 2 and XR screen 3 corresponding to product A, product B and product C respectively. If the user needs to purchase product A, the first terminal is used to take a picture of XR screen 1 and enter the transaction space where 100 shares of product A rights can be viewed. If the user needs to purchase product B or product C, the first terminal is used to take a picture of XR screen 2 or XR screen 3 and enter the transaction space where 100 shares of product B rights or 100 shares of product C rights can be viewed.

In another alternative embodiment, the virtual transaction space can also be entered by using a terminal to take images of physical products and identify them. As shown in FIG. 3, if the transaction link for the product right is associated with the product category, the first terminal obtaining the transaction link for the displayed product of the designated product owned by the second terminal, includes:
the first terminal taking a photo of a displayed product, identifying the photo to determine the category of the displayed product, and obtaining a corresponding transaction link for the product rights of a specified category based on the category of the displayed product.

For example, after a user comes to a merchant's physical store and sees a certain product on the shelf and wants to purchase multiple products of this category, he can use the first terminal to capture an image of the product. The first terminal has a built-in transaction space management program, which is configured with a product recognition model, through which images can be automatically and intelligently recognized to determine the category of the displayed product, and then the corresponding transaction link for the product right of a designated category can be obtained according to the category of the displayed product. By clicking on this transaction link, the virtual transaction space of the product right of this category can be entered. The product recognition model herein can use a target detection classification model based on machine learning. After the first terminal identifies the product category that the user wants to purchase based on the product recognition model, it can further distinguish the merchant where the product is currently located, so as to obtain the virtual transaction space of the product category of a specific merchant. For example, the method for the first terminal to determine the specific merchant corresponding to the transaction link that needs to be obtained can be: by positioning the first terminal and matching the location range of the merchant to determine the merchant where the first terminal is located, or by adding additional merchant identifications to products of different merchants, identifying the merchant identification based on images to determine the corresponding merchants, etc. After the first terminal determines the specific merchant and the designated product category that the user wants, it can query the transaction link for the specific merchant corresponding to the product category through a transaction link query platform. Alternatively, the merchant's transaction link corresponding to the product category can be attached to the product package or other locations on the shelf, so that the first terminal can obtain the required transaction link after obtaining the product image.

Web3.0 supports decentralized applications (DApps), which run on the blockchain and are open, transparent and programmable. DApps can provide various functions such as digital authentication, decentralized financial service, decentralized social network, etc. In another embodiment of the present disclosure, the decentralized payment and transaction can be implemented based on decentralized applications.

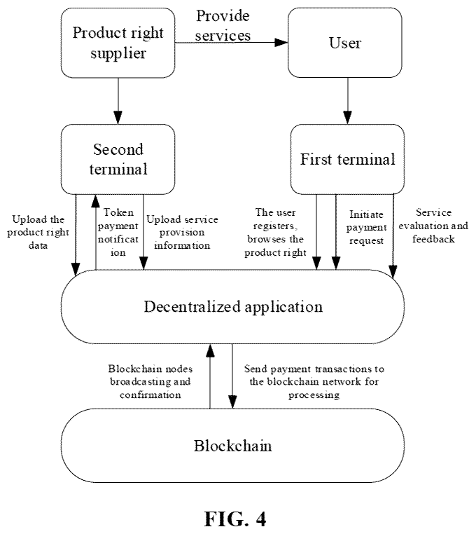

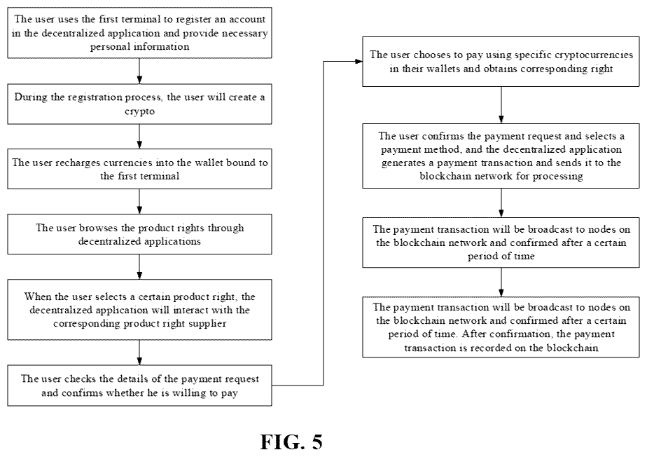

FIG. 4 is a schematic view of another implementation architecture of the blockchain-based decentralized payment method of the present disclosure. FIG. 5 is a schematic view of another specific progress of the blockchain-based decentralized payment method of the present disclosure. As shown in FIGS. 4 and 5, in another alternative embodiment, before the first terminal obtains the entry information of the transaction space of the second terminal, the merchant uses the second terminal to access API of the payment platform through a decentralized application, upload the product right data he owns to the blockchain, and binds each of the product rights to non-fungible tokens in a one-to-one correspondence. The first terminal obtains the transaction link for the product right of a specified category owned by the second terminal. Transactions are carried out through a payment platform. Specifically, the first terminal obtaining the transaction link for the product right of a specified category owned by the second terminal, includes:
the first terminal logging in a payment platform (such as DAOPAY Payment System), wherein the payment platform is configured to open the disclosure programming interface (API), and the second terminal is configured to access the payment platform through a created decentralized application (DApp) or through a sales platform of the existing Internet e-commerce and upload the owned product right data to the blockchain;
the first terminal retrieves and obtains products of specified categories or corresponding smart contracts through the payment platform, and obtains the transaction link for the product right of a specified category in the DApp.

Global product uploading can be achieved through the support of Web3.0 and the application of decentralized applications. The decentralized application needs to integrate all the applications in the real world, including: travel, entertainment, social networking, shopping and other real-world disclosures. The decentralized application can be configured as a new payment form for users to use.

As shown in FIGS. 4 and 5, for users, when they need to use decentralized applications to realize the product right transaction, the following steps are included (in the following steps, users refer to the user of the first terminal, and product right suppliers refer to merchants that own and sell product rights):

(1) User registration and login in: the user uses the first terminal to register an account in the decentralized application and provide necessary personal information. Once registration is successful, the user can log in to their accounts using their credentials.

(2) Wallet creation: during the registration process, the user will create a crypto wallet. This wallet owns the private keys of users and is used to store their cryptocurrencies and digital assets.

(3) Recharge: the user recharges currencies into the wallet bound to the first terminal (he can choose to add fiat currencies or other cryptocurrencies). The user can choose to convert the recharged amount into a specific cryptocurrency for use in the DApp.

(4) Browsing and selecting services: the user browses various product rights through decentralized applications, such as travel, entertainment, transportation, shopping, social networking, etc., and can specifically enter the page of the transaction space of the second terminal through decentralized applications, view the product right owned by the second terminal and sold externally (corresponding to physical products, electronic products, services, etc.). The user can choose and use these services according to their own needs.

(5) Payment request generation: when the user selects a certain product right, the decentralized application will interact with the corresponding product right supplier (the second terminal) and generate a payment request. The payment request includes details of the service, price and payment method. This step corresponds to the specific embodiment of steps S100 and S200 of the decentralized payment method of the present disclosure.

(6) Payment request confirmation: the user checks the details of the payment request and confirms whether he is willing to pay. Before confirming, the user needs to enter a password or use an authentication method such as biometric identification to ensure security.

(7) Payment method selection: the user chooses to pay using specific cryptocurrencies in his wallet and obtains corresponding product right. The decentralized application provides a payment interface that displays the user's available cryptocurrency balances and the corresponding exchange rate. This step corresponds to the specific embodiment of step S300 of the decentralized payment method of the present disclosure.

(8) Payment transaction initiation: once the user confirms the payment request and selects a payment method, the decentralized application generates a payment transaction and sends it to the blockchain network (payment platform) for processing. This transaction will include the payment amount, recipient address and other necessary information.

(9) Blockchain confirmation: the payment transaction will be broadcast to nodes on the blockchain network and confirmed after a certain period of time. Once confirmed, the payment transaction will be recorded on the blockchain and cannot be tampered with. The user owns the right of the product purchased. This step corresponds to the specific embodiment of step S400 of the decentralized payment method of the present disclosure.

Through the above steps (1)˜(9), the decentralized payment process based on decentralized applications is completed. The user of the first terminal obtains and owns the right of the product purchased, and the merchant of the second terminal obtains the tokens corresponding to the right of the product sold.

After completing the payment and transaction through steps (1) to (9), the management of the product right can also be realized. Specifically, once the payment transaction is confirmed, the product right supplier confirms that it will receive the payment notification and start providing corresponding services (such as mailing physical products, sending electronic products, generating travel orders, etc.). When the product right supplier completes the service, it uploads the service provision information through the decentralized application, which will confirm the completion of the service and record the service-related information on the blockchain. The user can evaluate and provide feedback on services.

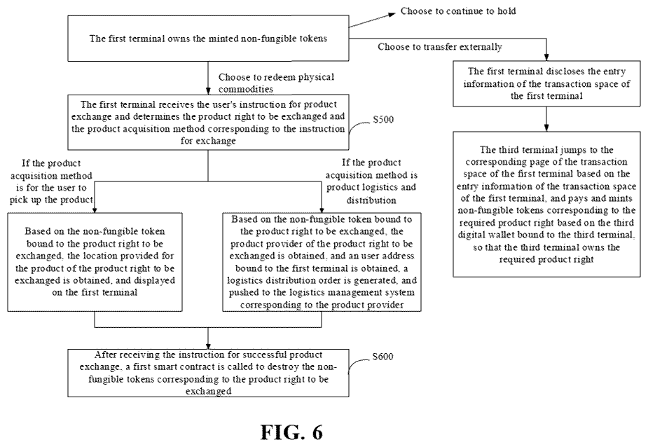

As shown in FIG. 6, after the first terminal pays and mints non-fungible tokens in the virtual transaction space, it obtains the product right corresponding to the minted non-fungible tokens. The user can choose to continue to own the product right without exchanging the physical product. At this time, the product can still be stored in the warehouse of the second terminal without transferring the location through logistics, and there is no need for the user to go to the physical store to pick up the product. The user can also choose to further transfer part or all of the product rights they own, that is, sell them to other users.

Specifically, when the user of the first terminal needs to transfer the product right owned by the user, the decentralized payment method also includes the following steps:
the first terminal disclosing the entry information of the transaction space of the first terminal or sending the entry information corresponding to the product right to a third terminal;
For example, the first terminal can disclose to the outside the transaction space link of a certain category of product right that needs to be sold externally. The disclosure method can be to publish it on a certain public website, and send the entry information corresponding to the product right to the third terminal, which is the process of DAS (DA-Send). For example, the first terminal sends the transaction space link point-to-point to another user's third terminal, or the first terminal shares the transaction space link to a certain Web2.0 or Web3.0 group, or the first terminal links the transaction space to the web page for sharing, etc.: for example, a user on the first terminal buys NFTs of 100 bottles of mineral water, converts 90 NFTs of mineral water into an entry link, and directly sends the information of this entry link to the third terminal used by friends around him, or sends it to a group. Users who receive this entry link can enter the payment terminal after clicking;
the third terminal skipping to the corresponding page of the transaction space of the first terminal based on the entry information of the transaction space of the first terminal. The page of the transaction space of the first terminal is configured to display the product rights that the user of the first terminal needs to sell externally. The third terminal pays and mints non-fungible tokens corresponding to the required product rights based on the third digital wallet bound to the third terminal, so that the third terminal owns the required product rights.

For example, if the first terminal purchases 50 shares of non-fungible tokens of product A rights from the transaction space of the second terminal, and then selects 30 shares of them for sale externally, then the transaction link for the 30 shares of product rights will be made public to the outside world. After the third terminal enters the transaction space of the 30 shares of product rights, it can choose to purchase the non-fungible tokens of 15 shares of the product rights, and pay the corresponding payable tokens in the third digital wallet to the first digital wallet of the first terminal. This payment and transaction process is open and transparent and fully recorded in the blockchain. Other users, such as the user of a fourth terminal, can also enter the transaction space of the remaining 15 shares of product rights for sale and purchase the non-fungible tokens of the remaining product rights.

As shown in FIG. 6, after the first terminal owns the minted non-fungible tokens, it can also choose to exchange the non-fungible tokens for physical products. Specifically, in the step S400, after the first terminal owns the product rights corresponding to the minted non-fungible tokens, the method further includes the following steps:

S500: the first terminal receiving the user's instruction for product exchange and determines the product right to be exchanged and the product acquisition method corresponding to the instruction for exchange:

S600: after receiving the instruction for successful product exchange, a first smart contract is called to destroy the non-fungible tokens corresponding to the product right to be exchanged. Herein, the first terminal or the second terminal may actively call the first smart contract after receiving a successful product exchange instruction, or it may also be that the product supplier other than the first terminal and the second terminal (that is, the actual storage location of the product) actively calls the first smart contract after determining that the product is successfully exchanged.

Non-fungible tokens are managed by the first smart contract on the blockchain. The first smart contract defines the behavior and properties of the non-fungible token and records the owner information, metadata and other references or links related to the non-fungible token. For destroying non-fungible token, interaction with the first smart contract is required to execute a specific destroy function or method. Depending on the blockchain network used, the process for destroying non-fungible tokens may vary. For public blockchains, such as Ethereum, the non-fungible token destroy function can be called by sending a special transaction for the purpose of destroying the non-fungible token.

When the non-fungible token is destroyed, the status of the non-fungible token in the first smart contract is updated, the non-fungible token is marked as destroyed, and the blockchain record related to it is deleted. By modifying the first smart contract, it is ensured that destroyed non-fungible tokens are no longer visible or accessible on the blockchain. Moreover, once a non-fungible token is destroyed, the operation is generally irreversible.

In this embodiment, said step S500: after determining the product right to be exchanged and the product acquisition method corresponding to the instruction for exchange, the method further includes the following steps:
if the product acquisition method is for the user to pick up the product, based on the non-fungible token bound to the product right to be exchanged, the provider location for the product of the product right to be exchanged is obtained, and displayed on the first terminal; the provider location for this product is the location where the product can be picked up. In the disclosure, the product may be placed in the warehouse of the second terminal, and the location provided for the product is the corresponding merchant location of the second terminal. However, when there is no specific warehouse at the second terminal, the product may always be placed in a distribution warehouse. If the second terminal only owns the product right but did not obtain the physical product, the location provided for the product is the pickup location corresponding to the distribution warehouse. After the location provided for the product is displayed on the first terminal, the user can go to the location provided for the product according to this location and exchange the non-fungible tokens for the physical product. After the on-site exchange is successful, the first smart contract will destroy the non-fungible tokens;
if the product acquisition method is logistics delivery, based on the non-fungible token bound to the product right to be exchanged, the product supplier of the product right to be exchanged is determined, and a user address bound to the first terminal is obtained, a logistics delivery order is generated, and pushed to the logistics management system corresponding to the product supplier. After receiving this logistics delivery order, the logistics management system of the product supplier will use the user's address as the delivery address. When the exchanged physical product is delivered to the logistics company, the first smart contract can be set to destroy the non-fungible tokens when the physical product is delivered to the logistics company, or the non-fungible tokens can be destroyed after the physical product is received by the user. Therefore, by combining uploaded product right data with smart contract technology, automated transaction and execution can be achieved. When the consumer purchases products, smart contracts can automatically execute payment and logistics arrangements, greatly improving transaction efficiency and reducing human errors. Moreover, for product suppliers, it can provide comprehensive visualization of the supply chain, allowing enterprises to better manage and optimize the supply chain process. By monitoring and tracking the location and status of products in the supply chain in real time, enterprises can adjust production plans, inventory management and logistics arrangements in a timely manner, improving the management efficiency and flexibility of the supply chain.

Therefore, by adopting the method of the present disclosure, when users need to use non-fungible tokens to exchange for physical products, they can directly obtain the corresponding physical products from the storage location where the products originate. Only one logistics distribution process is required, instead of transporting the products to the middleman first, and then from the middleman to the user, which greatly saves logistics costs and makes product circulation faster. In the traditional transaction model, it often needs to go through many levels of middlemen from the source of the product to the user, which require multiple transfers and distributions, and each level of middlemen must provide a separate warehouse, which not only generates a lot of intermediate costs, but is also time-consuming and laborious. At the same time, due to the substantial reduction in product display, it can reduce the dependence on packaging in product sales, reduce the waste of packaging materials, and promote the protection of global environment and ecology. For each level of sellers, their own profits can be increased due to reduction of intermediate costs. For users, they can also purchase lower-priced products, making both sellers and users more willing to participate in this payment method.

What the present disclosure provides is a brand-new payment architecture and product transaction architecture, which maps physical products to product rights, and then binds product rights to non-fungible tokens of the blockchain, realizing the mapping of physical products to virtual transaction space. After entering the virtual transaction space, users can openly, transparently and safely trade non-fungible tokens and payable tokens, and obtain the product rights they need. This process is digital and based on the network, which is more convenient and safer than direct transactions with physical products and cash.

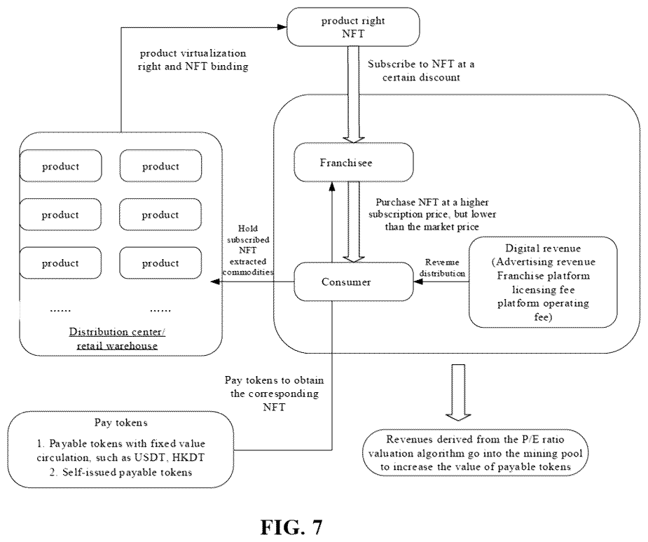

As mentioned above, by adopting the method of the present disclosure, unnecessary costs incurred in various links can be greatly reduced, thereby bringing more profits and benefits to each participant. As shown in FIG. 7, in this embodiment, the decentralized payment method may further comprise the step of distributing digital profits to beneficiaries. Specifically, the method comprises the following steps.

Obtaining the digital profits to be distributed and determining the non-fungible token corresponding to the digital profits: wherein the digital profits can be, for example, advertising profits for a certain category of product, franchise platform licensing fees, platform operating fees, etc.

Determining the beneficiaries corresponding to the digital profits based on the non-fungible token corresponding to the digital profits: the beneficiaries herein may include owners of the non-fungible tokens and contributors to the product right corresponding to the non-fungible tokens.

For example, in the process of selling product N of brand M across the entire network, the advertising for product N on the XR screen generates advertising profits, and the brand owner of brand M also provides part of the brand promotion and licensing profits, while several major distributors of product N also provide part of distributor profits due to the reduction of intermediate costs and the increase in profits. These profits are all classified as digital profits from product N. The beneficiaries of the digital profits of product N include the current owners of non-fungible tokens of product N, users who have purchased non-fungible tokens of product N and resold them to others, and users who have shared advertisements of product N on social platforms.

Calling a second smart contract to distribute the digital profits to be distributed to the beneficiaries.

For example, said calling the second smart contract distributes the digital profits to be distributed to the beneficiaries, includes the following steps:
obtaining the owning amount a and the owning time b of the product right owned by the beneficiaries;
obtaining the contribution behavior record c of the beneficiaries to the product right: this contribution behavior record includes, for example, the number of times a user shares a product, the number of times a user purchases a product, the number of times a user resells a product, etc.;
calculating the beneficiary's contribution value d according to the beneficiary's owning amount a, owning time b and said contribution behavior record c, based on the preset contribution value calculation method d=f (a,b,c): the specific calculation formula of the contribution value calculation method d=f (a,b,c) herein can be set according to different scenarios and product categories respectively, so that it can be a function associated with the owning amount a of the beneficiaries and the contribution behavior record b, for example, the weight k1 of owning amount a, the weight k2 of owning time b, and the weight k3 of contribution behavior record c, d-a*k1+b*k2+c*k3, etc. are set. This is just an example of a simple contribution value calculation method and is not intended to limit the scope of protection of the present disclosure;
calling the second smart contract, and calculating the profits value d distributed by each said beneficiaries, and distributing the digital profits to be distributed to the beneficiaries based on the contribution value of each said profits allocator. Therefore, by adopting this method, different users get an opportunity to change the identity of the consumer. Users can participate in and contribute to commercial activities and receive profits distribution corresponding to their contributions, which is conducive to encouraging more users to participate in this payment method.

A schematic decentralized transaction process is shown in FIG. 7. First, the warehouse of the distribution center/retail warehouse stores products of various product categories. The distribution center or retail warehouse uploads the product right data corresponding to the products stored in the warehouse that need to be traded in the virtual transaction space to the blockchain, and binds the product rights and non-fungible tokens in a one-to-one correspondence. Some of the non-fungible tokens are added to the digital wallet of the distribution center/retail warehouse. There are not only ordinary consumers in the Web3.0 system, but also one or more levels of franchisees. The franchisee can use a certain discount to pay the corresponding tokens (payable tokens or other equivalent non-fungible tokens) from the transaction space of the distribution center/retail warehouse to the digital wallet of the distribution center/retail warehouse, and mint a larger amount of non-fungible tokens of product rights, and this part of non-fungible tokens enter the digital wallet of the franchisee. In this process, there is no need to move the location of the physical products. The physical products are still stored in the warehouse of the distribution center/retail warehouse, and the franchisee only has ownership of this part of products. At the same time, the franchisee forms a prepayment model when minting larger quantities of non-fungible tokens of product rights, which can alleviate and save merchants' financial costs to a certain extent, reducing the impact of interest and financial market volatilities on the entire supply chain.

Therefore, in this embodiment, different product prices can be set according to the different quantities of product rights purchased by different users. For example, for franchisees, when the subscription volume is large, they can enjoy larger discounts, while for ordinary consumers, the purchase unit price will be higher. Specifically, before the step S400: the first terminal making payment in the transaction space of the second terminal using the first digital wallet based on transaction amount of the product rights selected by a user, the method further includes the following steps:
determining amount of product rights selected by the user;
based on a preset product right value calculation method, determining a unit price of the product rights and the value of the product rights selected by the user, with the value comprising transaction amount of payable tokens and/or transaction amount of non-fungible tokens. The preset product right value calculation method herein is a function related to the amount of product rights and the initial pricing of product rights. The calculation result is the unit price of the product right. For example, the unit price of the product right can be set as an initial pricing of the product right+a price variable. This price variable is inversely proportional to the amount of the product right. The greater the amount of the product right is, the lower the price variable will be. That is, the lower the unit price of the product right, after determining the unit price, the value of the product right=the unit price*the amount of product rights selected by the user.

As shown in FIG. 7, after a franchisee subscribes for non-fungible tokens corresponding to the product rights, consumers can enter a franchisee's virtual transaction space by taking a photo of XR screen or a photo of a physical product, to view and purchase a certain category of product rights owned by the franchisee. The purchase price of consumers will be higher than the subscription price of franchisees, but the purchase price of consumers will still be lower than the market price under the traditional market model as middlemen handling fees, warehousing fees, logistics fees, etc. are omitted. After consumers purchase part of the non-fungible tokens, they will own the product rights of this part of non-fungible tokens. During the process of product advertising and circulation, a certain amount of digital profits will be generated. This part of digital profits can be fed back to consumers who participate in product advertising and advertising circulation to encourage more consumers to participate in this payment method.

The above is a detailed description of the present disclosure in connection with specific embodiments, and the specific embodiments of the present disclosure are not limited to the description. Modifications and substitutions can be made without departing from the spirit and scope of the present disclosure.

What is claimed is:

1. A blockchain-based decentralized payment method comprising:
a first terminal obtaining entry information of a transaction space of a second terminal;
the first terminal skipping to a page of the transaction space of the second terminal based on the entry information, wherein the page is configured to display product rights owned by the second terminal, and the product rights are bound to non-fungible tokens;
the first terminal associating a first digital wallet of the first terminal with the transaction space of a second terminal;
the first terminal making payment in the transaction space of the second terminal using the first digital wallet based on transaction amount of the product rights selected by a user, and minting the non-fungible tokens bound to the product rights selected by the user, so that the first terminal owns the product rights corresponding to the minted non-fungible tokens.

2. The decentralized payment method according to claim 1, wherein the step of the first terminal obtaining the entry information of the transaction space of a second terminal comprises: the first terminal obtaining a transaction link for product rights of a specified category owned by the second terminal, wherein the page of the transaction space of the second terminal is configured to display the product rights of the specified category owned by the second terminal.

3. The decentralized payment method according to claim 2, wherein the step of the first terminal obtaining a transaction link for product rights of a designated category owned by the second terminal comprises: the first terminal taking a photo of a projection screen showing a product, and obtaining a transaction link for product rights of a designated category corresponding to the displayed product based on the projection screen.

4. The decentralized payment method according to claim 2, wherein the step of the first terminal obtaining a transaction link for product rights of a designated category owned by the second terminal comprises:
the first terminal taking a photo of a displayed product, identifying the photo to determine a category of the displayed product, and obtaining a transaction link for the product rights of a specified category corresponding to the displayed product.

5. The decentralized payment method according to claim 2, wherein the step of the first terminal obtaining a transaction link for product rights of a designated category owned by the second terminal comprises:
the first terminal logging into a payment platform, wherein the payment platform is configured with an application programming interface, and the second terminal is configured to access the payment platform through a created decentralized application or through an Internet e-commerce sales platform, and upload product right data owned by the second terminal to the blockchain;
the first terminal retrieving and obtaining product rights of a specified category or corresponding smart contracts through the payment platform, and obtaining the transaction link for the product rights of the specified category in the decentralized application.

6. The decentralized payment method according to claim 1, wherein before the first terminal obtaining the entry information of the transaction space of a second terminal, the method further comprises the following steps:
the second terminal uploading the product right data owned by the second terminal to the blockchain, and binding each product right with non-fungible tokens in a DA-Tie format.

7. The decentralized payment method according to claim 6, wherein the product right data at least comprises product category, product number, product specification, and production information corresponding to each product right.

8. The decentralized payment method according to claim 6, wherein after the first terminal owns the product rights corresponding to the minted non-fungible tokens, the method further comprises the following steps:
the first terminal receiving a product exchanging instruction from the user, determining the product rights to be exchanged and product acquisition method;
after receiving a successful product exchange instruction, the first terminal calling a first smart contract to destroy the non-fungible tokens corresponding to the product rights to be exchanged.

9. The decentralized payment method according to claim 8, wherein after the step of determining the product rights to be exchanged and product acquisition method, the method further comprises the following steps:
if the product acquisition method of the product is for the user to pick up the product, based on the non-fungible tokens bound to the product rights to be exchanged, the first terminal obtaining and displaying a location of the product corresponding to the product rights to be exchanged;
if the product acquisition method of the product is logistics delivery, based on the non-fungible tokens bound to the product rights to be exchanged, the first terminal obtaining information of a product supplier corresponding to the product rights to be exchanged, obtaining the user's address bound to the first terminal, generating a logistics delivery order, and pushing the order to a corresponding logistics management system of the product supplier.

10. The decentralized payment method according to claim 1 further comprising the following steps:
the first terminal disclosing entry information of a transaction space of the first terminal or sending the entry information corresponding to the product rights to a third terminal in a form of DA-Send;
the third terminal skipping to a page of the transaction space of the first terminal based on the entry information, making payment and minting non-fungible tokens corresponding to required product rights using a third digital wallet associated with the third terminal, so that the third terminal owns the required product rights.

11. The decentralized payment method according to claim 1 further comprising the following steps:
obtaining digital profits to be distributed and determining the non-fungible tokens corresponding to the digital profits;
determining the beneficiaries corresponding to the digital profits based on the non-fungible tokens corresponding to the digital profits;
calling a second smart contract to distribute the digital profits to be distributed to the beneficiaries.

12. The decentralized payment method according to claim 11, wherein the step of calling a second smart contract to distribute the digital profits to be distributed to the beneficiaries comprises the following steps:
obtaining holding amounts and durations of the product rights owned by the beneficiaries;
obtaining a contribution record of the beneficiaries to the product rights;
calculating contribution values of the beneficiaries based on a preset contribution value calculation method, according to the holding amounts, holding durations, and the contribution records of the beneficiaries;
calling the second smart contract, calculating income value distributed to each beneficiary, and distributing the digital profits to be distributed to the beneficiaries, based on the contribution value of each beneficiary.

13. The decentralized payment method according to claim 1, wherein before the step of the first terminal making payment in the transaction space of the second terminal using the first digital wallet based on the value of the product rights selected by a user, the method further comprises the following steps:
determining amount of product rights selected by the user;
based on a preset product right value calculation method, determining a unit price of the product rights and the value of the product rights selected by the user, with the value comprising transaction amount of payable tokens and/or transaction amount of non-fungible tokens.
